(19) United States
(12) Patent Application Publication
(10) Pub. No.: US 2007/0203794 A1
(43) Pub. Date: Aug. 30, 2007

(54) SYSTEM AND METHOD FOR PROVIDING A FUEL PURCHASE INCENTIVE WITH THE SALE OF A VEHICLE

(76) Inventors: Richard Stanley Hajdukiewicz, New York, NY (US); James P. Riley, Garden City, NY (US); John A. Squires, Franklin Lakes, NJ (US)

Correspondence Address: CHADBOURNE & PARKE LLP, 30 ROCKEFELER PLAZA, NEW YORK, NY, 10112, US

(21) Appl. No.: 11/733,125

(22) Filed: Apr. 9, 2007

Related U.S. Application Data
(62) Division of application No. 09/853,196, filed on May 11, 2001.
(63) Continuation-in-part of application No. 09/819,338, filed on Mar. 28, 2001, now Pat. No. 6,980,960.

(51) Int. Cl. G06Q 30/00; G06F 17/00

(52) U.S. Cl. 705/14; 705/400

(57) ABSTRACT

A fuel purchase incentive is provided incident to the sale of a vehicle. With respect to the sale of an automobile, the incentive consists of a program price, for example a discount price or a capped maximum price, for a specified quantity of a specified brand and type of gasoline. The incentive is calculated as a function of the anticipated fuel use factors of the automobile buyer. The incentive information is provided to the buyer at the time of purchase of the automobile and stored for use by an incentive program operator. When the buyer purchases gasoline pursuant to the incentive program, the buyer recognizes the program price through the provision of a rebate, credit, real-time discount or other appropriate mechanism. Program sponsors may participate in the fuel incentive program, for example providing a payment(s) to the program operator in exchange for establishing a relationship with a customer under the program. The program operator may hedge the financial risks associated with the volatility of fuel prices. Different mechanisms are provided whereby the customer may identify himself as a program participant, select a payment mechanism or account under the program and receive the program price. The invention has application to vehicles other than automobiles and fuels other than gasoline. In one embodiment, a hedge program may be developed to offset the risk associated with guaranteeing the price of the fuel.

### RELATED APPLICATIONS

This application is a divisional application of U.S. application Ser. No. 09/853,196 filed May 11, 2001, which is a continuation-in-part of U.S. application Ser. No. 09/819,338 filed Mar. 28, 2001, now U.S. Pat. No. 6,980,960 issued Dec. 27, 2005, both hereby incorporated by reference.

### FIELD OF THE INVENTION

The present invention relates generally to incentive programs and more particularly to methods and systems for facilitating a vehicle sales incentive program including a program price for fuel.

### BACKGROUND OF THE INVENTION

In order to both increase sales and control inventory, many automobile manufacturers provide incentive programs to stimulate the sale of automobiles. Such incentive programs are typically executed through the local dealer at the time of purchase.

Many different types of automobile sales incentive programs are known to those skilled in the art, including for example, incentive programs relating to financing, cash-back to the customer and various free maintenance and extended warranty programs.

In a typical incentive financing program, an automobile manufacturer may offer a combination of interest rates and payment schedules that are generally more favorable than those available through conventional bank financing. In a cash-back incentive program, a manufacturer may offer a predetermined sum of cash back to a buyer, the cash being available to the buyer to either lower the purchase price of the automobile or to simply take and use for other purposes. Such programs are offered to customers through local dealers, with the costs, and in many cases the implementation and processing, being subsidized by the manufacturer.

In a typical free maintenance program, a buyer is offered free maintenance for some period of ownership. Again, a local dealer runs the program with the guidelines provided and the costs typically absorbed by the manufacturer. The same is true with an extended warranty program, whereby a dealer offers the extended warranty in accordance with terms set by the manufacturer, with dealer maintenance costs being reimbursed by the manufacturer.

Incentive programs have become an ingrained part of the automobile sales process. With the exception of limited, high-demand automobiles, incentives are often necessary for a manufacturer to maintain desirable sales levels. Incentives also have the benefit of providing the manufacturer the ability to control inventory. If, for example, a manufacturer anticipates the release of a new model, incentives may be applied to a current model in order to avoid a backlog of older cars after the introduction of the newer cars.

Buyers generally understand that the purchase price of an automobile represents only a partial cost of automobile ownership. There are, for example, additional operating costs such as fuel, oil, tires and maintenance. There are finance costs. There is the cost of insurance, required by law in most states. Further there is the loss-of-use costs for the monies invested in purchasing and/or leasing the automobile. Buyers increasingly look to manufacturer incentive programs to help defray the total cost of automotive ownership.

In addition to the benefits to both manufacturers and buyers described above, automobile sales incentive programs provide the additional benefit of enabling a buyer to purchase a more expensive vehicle. The provision, for example, of cash back, enables a buyer to use that cash to purchase a more expensive automobile than they may have otherwise been able to afford. Other incentives that defray total ownership costs likewise have the result of enabling a buyer to ‘buy up’ to a better automobile. This provides a benefit both to the automobile manufacturer, who can sell a more expensive car, and also to the buyer, who can purchase a better car than they might otherwise have been able to afford.

In U.S. patent application Ser. No. [by Hajdukiewicz, Richard filed April [______] 200] there are provided systems and methods for providing vehicle purchase incentive programs that cap or lower the cost of fuel as an operating cost to the buyer. Such programs directly lower the cost of vehicle ownership to provide a significant purchase incentive to a buyer. The costs associated with providing such programs, however, may be significant. The volatile nature of fuel oil costs may also make the ultimate cost of such programs somewhat unpredictable.

Automobile incentive programs, particularly those such as the above-described fuel incentive programs that directly lower buyer ownership costs, have recognized benefits to both buyers and sellers. Because automobile sales represent a significant portion of consumer transactions in many countries, such incentive programs have the further benefit of improving the overall economy.

### SUMMARY OF THE INVENTION

The present invention provides methods and systems that enable a manufacturer or other vehicle distributor to effectively provide a vehicle purchase incentive program that caps or lowers the cost of fuel as an operating cost to the buyer. More particularly, the present invention provides systems and methods for financially hedging and otherwise diminishing the costs and volatilities associated with such incentive programs.

The present invention further provides features whereby various program sponsors can contribute financial value to the incentive system operator in exchange for the establishment of customer accounts.

Yet other features of the present invention provide the ability for a customer purchasing fuel under the incentive program to flexibly select a payment mechanism and recognize the fuel purchase incentive.

In one embodiment of the invention there is provided methods and systems, the method operable on a computer for providing a program price for the purchase of a vehicle fuel, the method comprising the steps of: receiving usage data; receiving program sponsor data; calculating, on the computer, using the usage data and the program sponsor data, the program price for the vehicle fuel; guaranteeing the program price; and storing the program price on the computer for use in association with a purchase of the vehicle fuel.

In another embodiment of the invention there is provided methods and systems, the method operable on a computer for providing a program price for the purchase of a vehicle fuel, the method comprising the steps of: receiving usage data; receiving program sponsor data; calculating, on the computer, using the usage data and the program sponsor data, the program price for the vehicle fuel; guaranteeing the program price; developing, using the usage data and the program sponsor data, a financial hedging strategy to diminish the risk associated with the guaranteeing of the program price; and storing the program price on the computer for use in association with a purchase of the vehicle fuel.

In another embodiment of the invention there is provided methods and systems, the method operable on a computer for providing a program price for the purchase of a vehicle fuel, the method comprising the steps of: receiving usage data; receiving program sponsor data; determining a market indicator relevant to the future price of the vehicle fuel; calculating the program price; guaranteeing the program price; developing, using the usage data, the program sponsor data and the market indicator, a financial hedging strategy to diminish the risk associated with the guaranteeing of the program price; and storing the program price on the computer for use in association with a purchase of the vehicle fuel.

In yet another embodiment of the invention, there is provided methods and systems, the method operable on a computer for processing a payment due on a purchase of a vehicle fuel by a customer, the method comprising the steps of: receiving purchase data describing a purchase of the vehicle fuel by the customer, the purchase data including an account identifier and a purchase price; receiving a payment identifier of a payment mechanism for use in paying for the purchase of the vehicle fuel; retrieving from the computer, using the account identifier, a program price associated with the account identifier; calculating on the computer a discount due to the customer based in part on the difference between the program price and the purchase price; and initiating a payment for the purchase of the vehicle fuel using the payment mechanism.

In another embodiment of the invention there is provided methods and systems, the method being one of purchasing a vehicle fuel at a discounted program price, the method comprising the steps of: providing an account identifier identifying a program price for the vehicle fuel; providing a payment identifier identifying a payment mechanism; and purchasing the vehicle fuel with the payment mechanism at the program price.

### DESCRIPTION OF THE FIGURES

These and other objects, features and advantages of the invention will be apparent from a reading of the attached Detailed Description of the Invention in association with the drawing Figures, the contents of which are described immediately below.

FIG. 1A is a block diagram illustrating a system for administering an incentive program in accordance with the present invention.

FIG. 1B is a block diagram illustrating an alternate system for administering an incentive program in accordance with the present invention.

FIG. 2 is a flow chart illustrating a process by which an automotive dealer may initiate a gasoline incentive program.

FIG. 3 is a flow chart illustrating a process by which an incentive provider may calculate the parameters of a gasoline incentive program.

FIG. 4A is a flow chart illustrating a process by which a customer may purchase gasoline and receive an incentive in accordance with the present invention.

FIG. 4B is a flow chart illustrating an alternate process by which a customer may purchase gasoline and receive an incentive in accordance with the present invention.

FIG. 5A is a table illustrating an exemplary customer incentive database record as may be stored in the customer incentive database of FIG. 1.

FIG. 5B is a table illustrating an alternate embodiment of a customer incentive database record as may be stored in the customer incentive database of FIG. 1.

FIG. 6 is a table illustrating an exemplary gasoline purchase database record as may be stored in the customer incentive database of FIG. 1.

FIG. 7 is a table illustrating an exemplary automobile sales database record as may be stored in the automobile sales database of FIG. 1.

FIG. 8 is a flow chart illustrating a process by which a customer rebate incentive may be calculated and applied to a customer credit card bill in accordance with the present invention.

FIG. 9 is a table illustrating an exemplary calculation of a customer rebate incentive in accordance with the process of FIG. 8.

FIG. 10 is a table illustrating an exemplary credit card database record as may be stored in the credit card database of FIG. 1.

FIG. 11 is a flow chart illustrating a process by which an incentive system program operator establishes financial relationships with other program participants.

FIG. 12 is a flow chart illustrating a process in accordance with the present invention for developing a hedge program to diminish the financial risks associated with a fuel incentive program.

### DETAILED DESCRIPTION OF THE INVENTION

### Definitions

It will be understood that the terms “vehicle,” “automobile,” “auto,” and “car,” as well as variants thereof, are used interchangeably throughout this document to mean all fuel-powered motor conveyances including without limitation: cars, vans, sport-utility vehicles, trucks, motorcycles, boats, aircraft and analogous means of fuel-powered conveyance.

It will be understood that the use of the terms “sale” and “purchase”, or variants thereof, are used interchangeably throughout this document to mean sales and/or leasing of vehicles to buyers.

It will be understood that the terms “gasoline,” “gas,” and “fuel,” or variants thereof, are used interchangeably throughout this document to indicate vehicle fuel. It will be understood that the terms include all vehicle fuels including gasoline, diesel fuel, methane and other liquid and gaseous fuels, and all other fuels which are used to power a fuel-powered vehicle.

It will be understood that the term “program price” and variants thereof are used interchangeably throughout this document to indicate a price for the purchase of fuel by a consumer pursuant to the incentive program of the subject invention. As described in further detail below, many different methodologies are described for calculating a program price in accordance with the present invention.

System

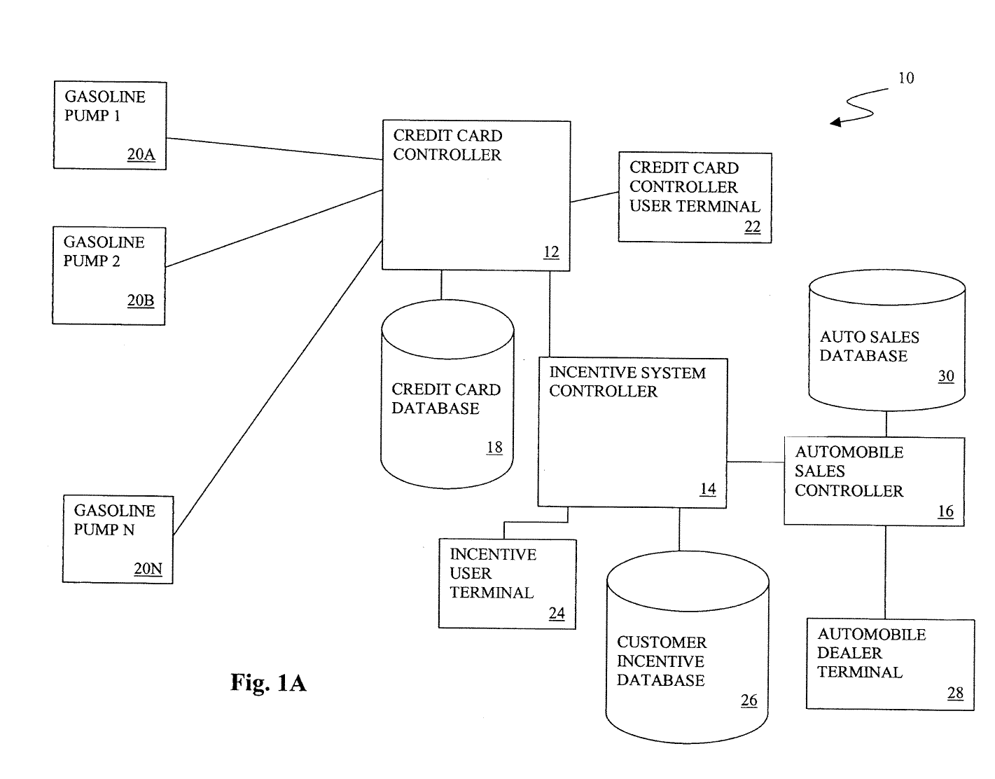

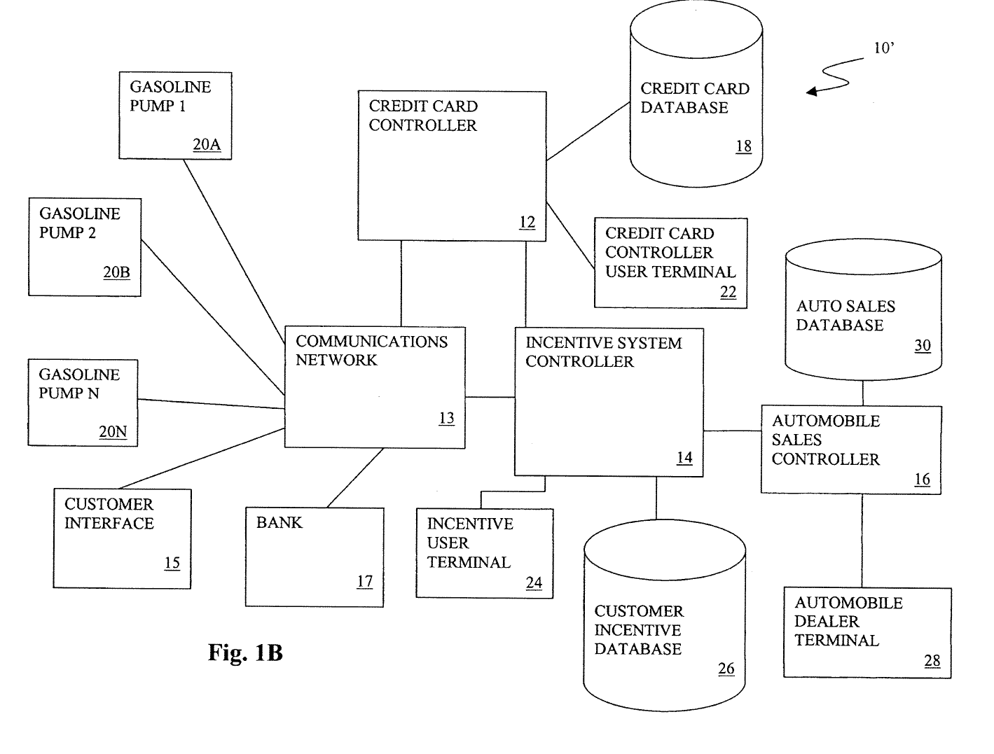

With reference now to FIG. 1, there is shown a computer system 10 including a credit card controller 12 connected to an incentive system controller 14 which is in turn connected to an automotive sales controller 16. Each of controllers 12, 14 and 16 comprises a conventional computer, for example an IBM-compatible, Microsoft Windows™-operated computer of a type well known in the art. As will be described in further detail below, controllers 12, 14 and 16 are typically geographically separate, with illustrated communications links comprising typical networking connections, many types of which are well known to those skilled in the art. Controllers 12, 14 and 16 are connected so as to facilitate the exchange of data in a manner described in detail herein below.

Continuing with reference to FIG. 1, credit card controller 12 is seen to support a credit card database 18 as well as communications links to remotely located gasoline pumps, three of which are shown at 20A, 20B and 20N. Credit card controller 12 is further seen to support a local user terminal 22 by which a user may enter both data and operating software and instructions. In addition to operating software and conventional credit card information typically stored in a credit card database, as is described in further detail below, database 18 includes information identifying credit card holders participating in the incentive program described herein.

While for purposes of illustration, gasoline pumps 20A-N are shown connected to credit card controller 12, it will be understood that they are typically geographically remote from the controller. Gasoline pumps are, of course, typically maintained and operated at service stations. Credit card controller 12 may be maintained and operated, for example, by a credit card company such as Visa™ or Mastercard™. It is commonly known today to provide customers with the ability to purchase gasoline using a credit card directly at a pump or a co-located payment terminal. It will be understood that the use of the term “credit card” herein includes debit cards, Automated Teller Machine (ATM) cards and other standard cards and account identifiers used by consumers. Numerous arrangements of networks and intermediate controllers and communications links to provide gasoline purchase information including credit card numbers and purchase prices to credit card processors are well known to those skilled in the art.

Still with reference to FIG. 1, incentive system controller 14 is seen to support a local user terminal 24 for entering data, software and control information into the controller. Controller 14 further supports a customer incentive database 26 for storing customer incentive information as described in further detail below.

In a similar manner, automotive sales controller 16, connected to incentive system controller 16 as described above, supports both a local terminal 28 and an auto sales database 30.

It will be understood that, with the exception of the data contents and control instructions as described herein, databases 18, 26 and 30 comprise conventional storage facilities, for example appropriate combinations of semiconductor, magnetic and optical storage medium. Terminals 22, 24 and 28 likewise comprise conventional computer terminals, for example including displays, keyboards and related data entry devices.

With respect to the parties associated with the practice of the invention, the credit card controller is operated by a credit card company as described above. The automotive sales controller may be operated by an automobile manufacturer with terminals distributed at local dealerships or may be operated at the location of an individual automobile dealer. The incentive program itself is preferably sponsored by an automobile manufacturer who supplies the automobile dealer and may further be co-sponsored by other parties of interest as described below. The operation of the incentive system controller to support the program may be by the automobile manufacturer or by a third party, for example an investment bank, an investment broker, another financial institution or others having the capability to operate such a system.

With reference now to FIG. 1B, an alternate embodiment 10′ of the system 10 above is shown wherein like elements are indicated by like reference numerals. System 10′ is substantially identical to system 10 with the exception that the various parties including the gasoline pumps 20A-N, credit card controller 12 and system incentive controller 14 communicate through a wide area communications network 13 such as the World Wide Web, or Internet. Further connected to network 13 are a variety of product and service providers including a customer interface 15, for example a personal computer or a user terminal located at the gasoline station or remotely, and one or more customer banks 17.

With further reference to FIG. 1B, system 10′ operates similarly to system 10 with the exception that the customer has a larger range of options by which to pay for purchased fuel. The customer may, for example, initiate a cash transfer from bank 17 to the gasoline pump operator through customer interface 15. The customer may chose to pay by credit card or even to pre-pay a gasoline purchase from a personal computer interface before arriving at the gasoline station to take possession of the fuel.

Data Records

There will now be described exemplary data fields for facilitating the system operation described further below.

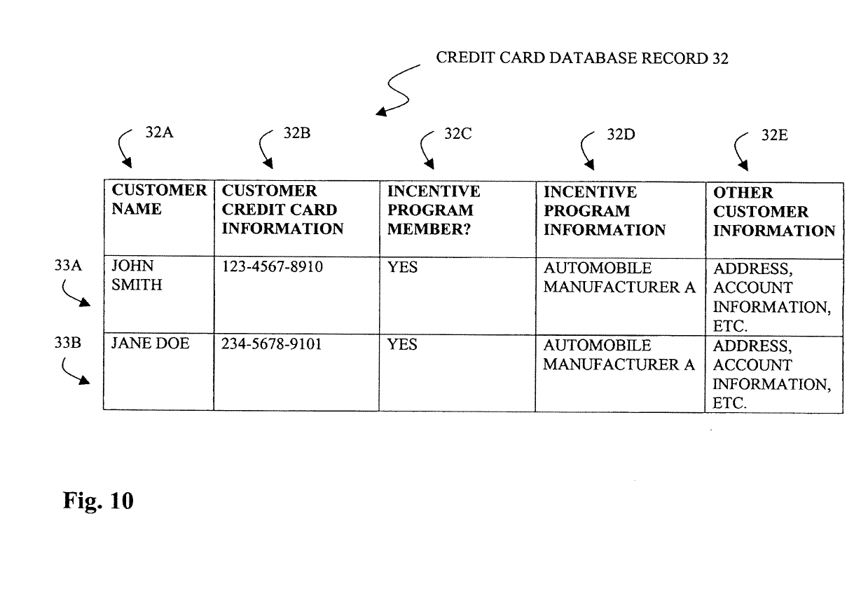

With reference now to FIG. 10, an exemplary credit card database record 32 from credit card database 18 is shown including two data entries 33A, 33B, each entry including five data fields 32A-E. A customer name field 32A includes a customer name. A credit card information field 32B includes a customer credit card number or equivalent account identifier. An incentive program member field 32C indicates whether the customer is an active member of a fuel purchase incentive program, while additional program information is stored in an incentive program information field 32D. The later incentive program information is sufficient to identify an incentive program including communications information enabling credit card controller 12 to exchange data with incentive system controller 14. An additional field 32E is shown to indicate the storage of other information known in the art as necessary to manage a credit card customer account.

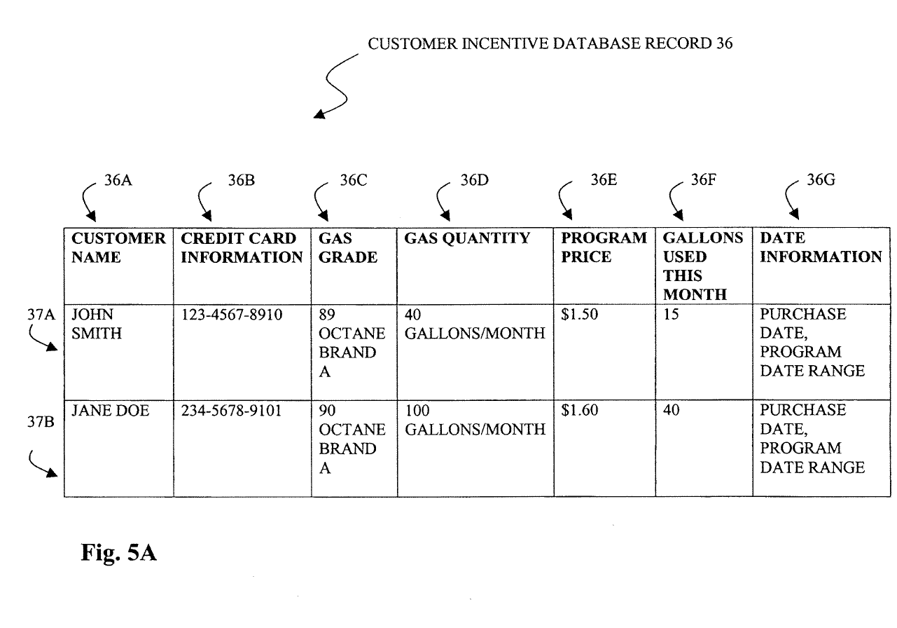

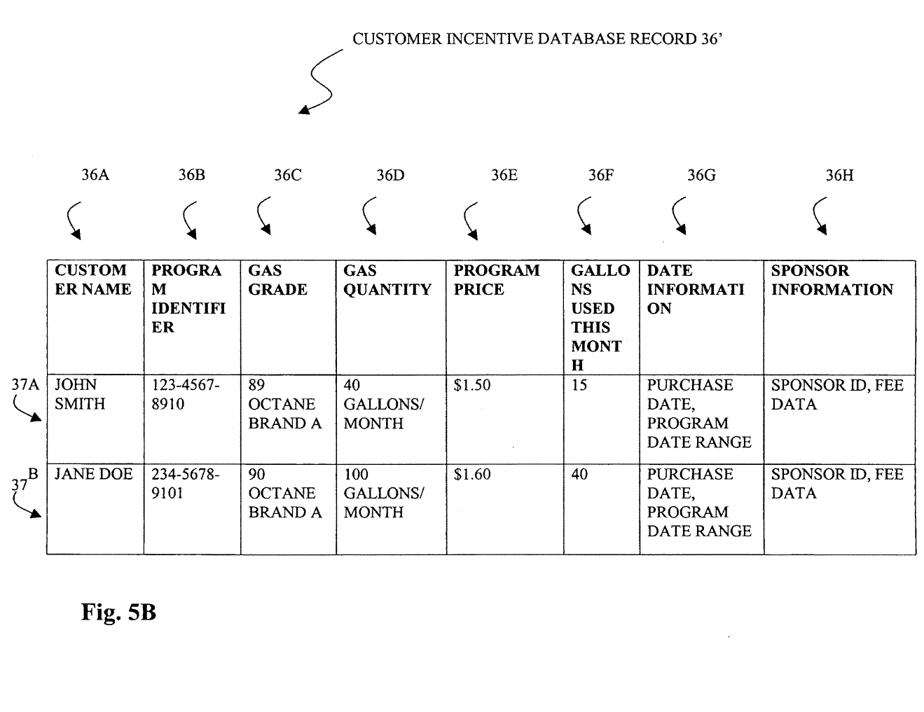

With reference now to FIG. 5A, there is shown an exemplary customer incentive database record 36 from customer incentive database 26 including two data entries 37A-B, each entry including six data fields 36A-F. Data fields 36A and B store a customer name and credit card number (or equivalent account identifier), respectively. Fields 36C and D describe a type of fuel, in this case a grade and brand of gasoline, and a quantity of fuel, in this case in gallons/month, that are covered by the incentive program. Data field 36E indicates the incentive program price in dollars per gallon, while data field 36F shows the number of gallons of fuel purchased by the consumer under the incentive program in a given month to date. A field 36G indicates the date range of the program, shown here as including the purchase date of the vehicle and the length of the program following the purchase date.

With reference now to FIG. 5B, there is shown an alternate embodiment of a customer incentive database record 36′, wherein like features to database 36 of FIG. 5A are identically numbered, and with the addition of a sponsor information data field 36H. Further, the credit card information field 36B has been broadened to include a program identifier, such as a credit card identifier, a gasoline purchase card identifier or any other program identifier the use of which associated with the purchase of fuel will identify the customer as a program participant.

In this embodiment of the invention, as is described in further detail herein below, a sponsor agrees to co-pay a portion of the fuel purchase incentive. Such a sponsor may include, for example and without limitation, a credit card company or issuing bank, a fuel provider such as a gasoline company, a dealer or reseller of the purchased vehicle or any other sponsor committed to make a financial payment towards the fuel incentive program.

Still with reference to FIG. 5B, a sponsor co-payment may comprise a one-time payment or a payment to be made upon the occurrence of an event such as a purchase of fuel by a customer. Field 36H contains all relevant information identifying the program sponsor and the type and size of the co-payment(s).

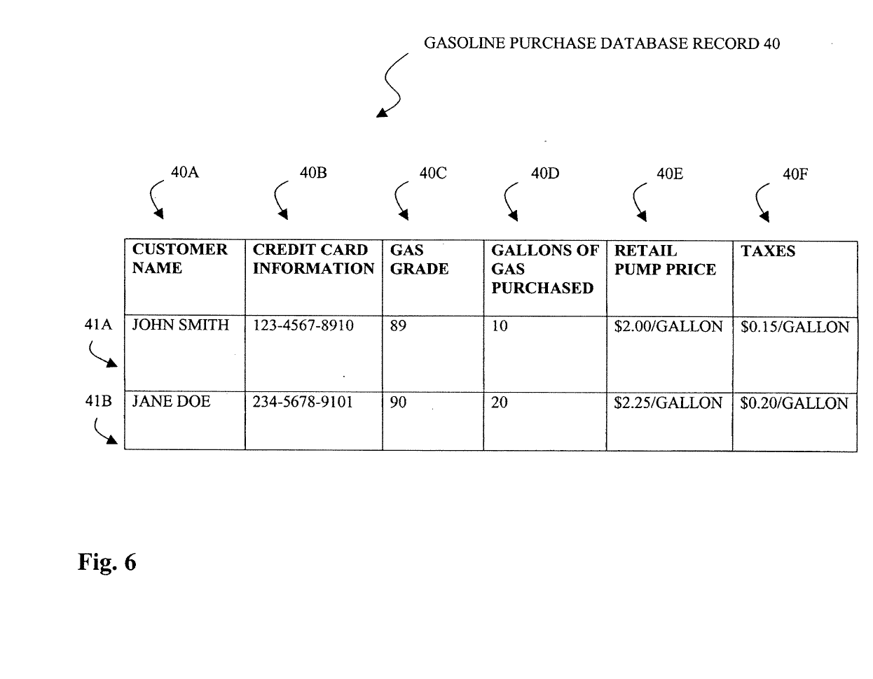

With reference now to FIG. 6, there is shown an exemplary gasoline purchase database record 40 as may be stored in credit card database 18 as a result of a fuel purchase at a pump 20. Subsequently, as described below, information from this record is used in combination with information in customer incentive database record 36 to compute a customer incentive. Database record 40 is seen to include two entries 41A and 41B, each entry comprising six fields 40A-F. Database fields 40A, B comprise a customer name and credit card account number (or equivalent account identifier), respectively. Data fields 40C and 40D store the type, in this exemplary case the grade and brand, and the quantity in gallons of a recent fuel purchase, respectively. Fields 40E and 40F contain the retail pump price and the component of tax within that sales price. Various sources of sales tax information are contemplated by the present invention as described below.

In one embodiment of the invention, the data in gasoline purchase database record 40, in addition to being stored in credit card database 18, is also stored in customer incentive program database 26. This is desirable to track incentive program fuel purchases made using methods of payment other than credit cards in the manner described below. It will be further understood that credit card identification field 40B may store any appropriate program identifier used to identify a program sponsor identified by the customer at the time of the fuel purchase. The storage of such a data record in customer incentive program database 26 enables both program tracking by the incentive program operator as well as any necessary financial settlement between the program operator, customer and sponsor, various ones of which are described herein.

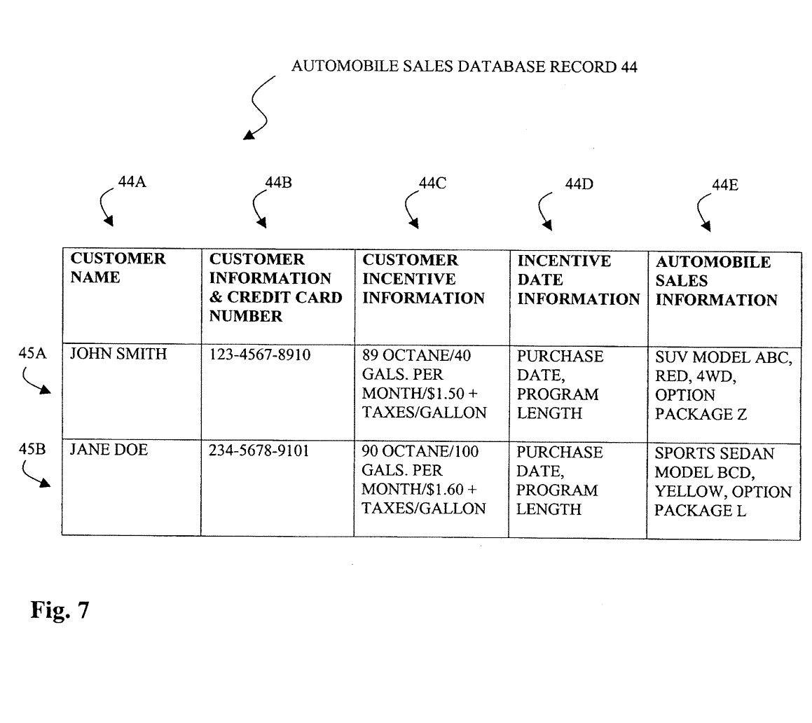

With reference now to FIG. 7, an exemplary automobile sales database record 44 is shown as may be stored in auto sales database 30. Record 44 contains two entries 45A and B, each of which includes four fields. Data field 44A includes a customer name, while data field 44B includes personal customer information relating to an automobile sale, including for purposes of this invention a credit card account number (and/or other program sponsor account identifier). Field 44B or other fields may further include numerous additional data as may be relevant to the automobile dealer and manufacturer, for example customer address, demographics, etc. A data field 44C includes customer incentive information, including the grade, brand, quantity and program price of the fuel purchase incentive. A field 44D includes incentive program date information such as a purchase date and program length. A field 44E includes other automobile sales information, which may be of interest or use to a dealer or manufacturer, for example the type, model and color of the automobile purchased.

In the event that a customer chooses to pre-pay for the purchase of gasoline, appropriate data relating to the prepayment including, for example, the amount of the prepayment and the account identifier, are stored in customer incentive database 26 and in the prepaid account, for example credit card database 18 if the prepaid account is a credit card account. Other accounts that may store and subsequently be debited for prepaid funds for fuel purchase include, for example and without limitation, a debit account, a bank account and a savings account, as well as any other financial account into which moneys may be prepaid and subsequently spent in accordance with the present invention.

It will be understood that the data records as described herein are exemplary of the present invention and numerous other configurations as well as data storage arrangements will now be apparent to those skilled in the art.

Operation of the System

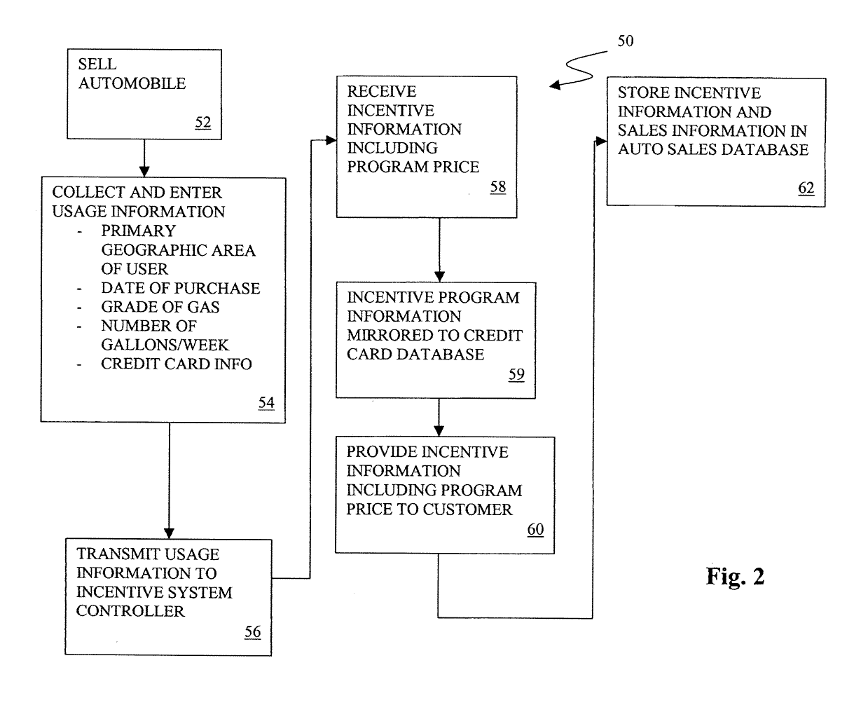

The various processes associated with the operation of the system will now be described with respect to FIGS. 2, 3, 4A, 4B, and 8-12.

With reference first to FIG. 2, a process 50 is shown for establishing the fuel incentive program of the subject invention incident to the sale of a vehicle. For purposes of illustration, the invention is described relative to the sale of an automobile pursuant to a gasoline purchase incentive program.

Incident to the sale of an automobile by an automobile dealer (step 52), the dealer collects usage information relating to the anticipated use of the vehicle by the buyer and enters same into automobile sales controller 16 (step 54). Such usage information includes data relative to the calculation of a gasoline program price, such as: the primary geographic area of the user, the date of purchase of the vehicle, the grade of gasoline to be purchased by the buyer, the number of gallons per week that the buyer anticipates purchasing for the automobile, and the buyers credit card information. In a first embodiment of the invention, the customer may indicate his preference as to a brand of gasoline. In another embodiment, the brand may be determined by the provider of the incentive program. Similarly, in one embodiment of the invention the customer may indicate the desired or anticipated fuel usage. In an alternate embodiment of the invention the program operator predetermines the fuel quantity available under the incentive program. In the described embodiment, the quantity of fuel made available under the incentive program will be indicated in gallons per month. This information is stored in the customer incentive field 44C of automobile sales database record 44 (FIG. 7).

Subsequent to the collection of the information, all relevant information necessary to the calculation of a program price (the calculation process being described below) is transmitted from automotive sales controller 16 to incentive system controller 14 (step 56). The incentive system controller is used to calculate a program price and other information and parameters pertinent to the incentive program (described in detail below) and the incentive program information is transmitted back to and received by automotive sales controller 16 from incentive system controller 14 (step 58). A copy of the incentive program information is further transmitted to credit card controller 12 where it is indexed by a customer identifier such as the credit card number and a flag set (field 32C of credit card database record 32 (FIG. 10)) indicating that the customer is a participant in the program (step 59). The incentive system controller, in a manner described below, stores a copy of the incentive program data in customer incentive database 32.

Subsequently, a copy of the incentive program information, along with directions for its use, is provided to the customer (step 60). A permanent copy of the incentive program information is stored in automotive sales database record 44 for future use by the automobile dealer and/or the automobile manufacturer (step 62).

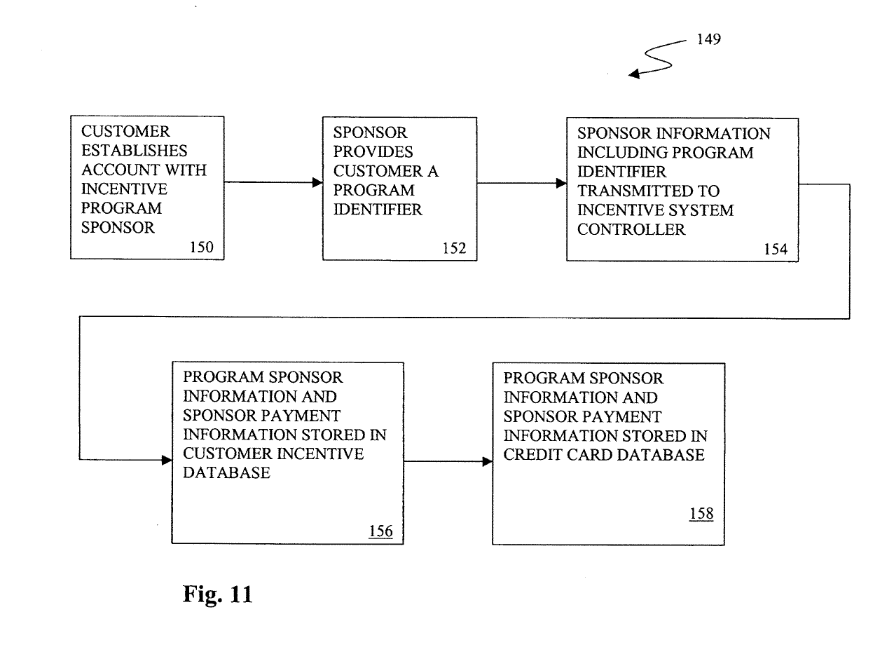

With reference now to FIG. 11, in one embodiment of the invention illustrated in flow chart 149, as a condition to a buyer participating in the incentive program, the buyer is required to establish a co-branded or affinity or other relationship with a program sponsor, for example and without limitation, with the automobile dealer, with a credit-card company or issuing bank, or with a participating gasoline dealer or other participant in the transaction (step 150). The sponsor provides the customer an identifier such as an account number (step 152), and the sponsor information including the program identifier is transmitted to (step 154) and stored in (step 156) the customer incentive database record in the customer incentive database. The program identifier is also stored in credit card database 18 (step 158), for example in the customer credit card information field 32B (if the identifier is a customer credit card account number) or in incentive program information field 32D (FIG. 10), and used to track the buyer's participation in the program.

In this embodiment of the invention, a fee for the establishment of the new account relationship is paid to the program operator by the program sponsor, The fee may be in the form of a one-time payment, for example a one-time finder's fee paid by a credit card company to the incentive system operator for the establishment of the new credit card account by the customer. The fee may also be in the form of a series of payments conditioned upon an event. For example, the fuel distributor, in this example the gasoline company, may pay a fee for each purchase of fuel by a customer under the incentive program.

These fees may be used by the incentive system operator in calculating the customer program price and developing a financial risk hedge strategy as described below. The fees may also be used, particularly the smaller periodic fees, as direct credits to lower customer prices under the plan. The fee is used by the operator of the program to lower the program price or hedge his own costs and financial risks in a manner described herein below.

In an embodiment of the invention, the customer may prepay the discounted price of the fuel anticipated to be purchased under the program. It may be desirable to the customer to set aside those funds while they are available. As described above, the funds may be set aside in an appropriate account selected by the customer and approved for use in the program by the system incentive program operator. Depending on the account selected and approved, the system incentive program operator may have access to the interest generated by the prepaid funds and may use the interest in developing the financial risk hedging strategies described herein.

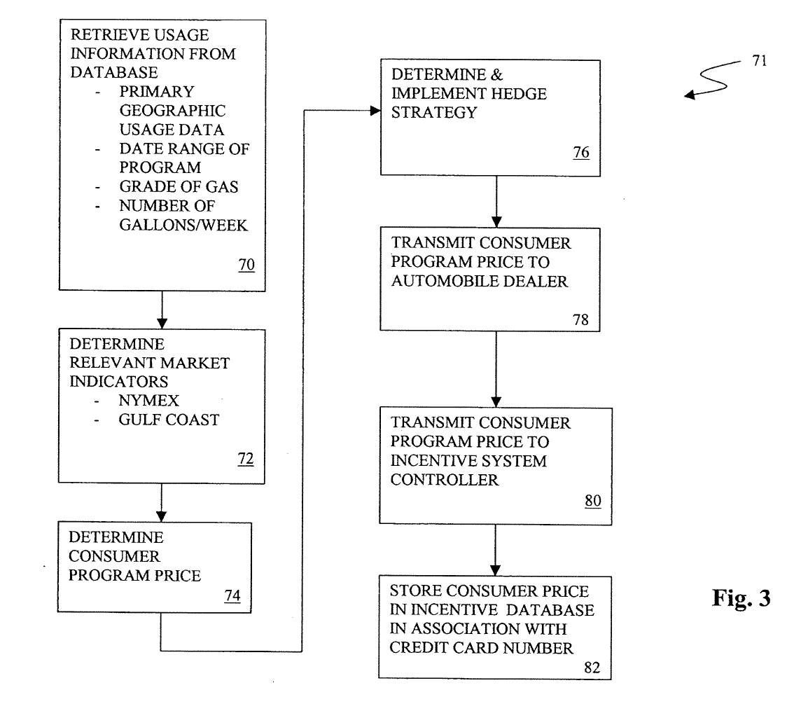

With reference now to FIG. 3, there is shown a process 71 for determining a program price for the fuel purchased under the incentive program of the present invention. Initially, the type, quantity, date range of the program, anticipated geographic area of fuel purchases and any other information relevant to the future cost of gasoline is retrieved from customer incentive database record 36 (step 70). Subsequently, relevant market factors are considered, including for example the current and futures prices for gasoline available through the NYMEX and Gulf Coast gasoline exchanges (step 72) and a consumer program price for the incentive program is calculated (step 74). Optionally, as described below, a hedge program may be determined and implemented by the program operator to hedge risks associated with the program (step 76).

It will be understood that the commodity price of gasoline can be hedged through the purchase of appropriate financial derivatives, including futures contracts and options. However, in addition to the actual gasoline commodity price, there are additional, more volatile costs associated with the delivery of gasoline to the pump. These costs include for example the cost of transportation, the retail margin and both federal and local taxes. No traditional hedges exist for these more volatile costs. Accordingly, there will be many different methods of calculating a consumer program price under the present incentive program. Without limitation, different methodologies include: including the tax as a fixed cost included within the program price and assuming the risks associated with fluctuations of the tax; adding the actual tax associated with each purchase into the program price such that the program price comprises a fixed base price plus tax; providing a single, geographically independent program price; and, providing a series of program prices that vary with the geographic location of the gasoline fuel purchase.

With further consideration of the setting of a program price, as described in further detail below, the program price may constitute a discount to a retail price, or a cap on the maximum price a participant will pay. When a cap price is set, a consumer will be free to purchase gasoline at any lower market price should the market price be less than the capped program price.

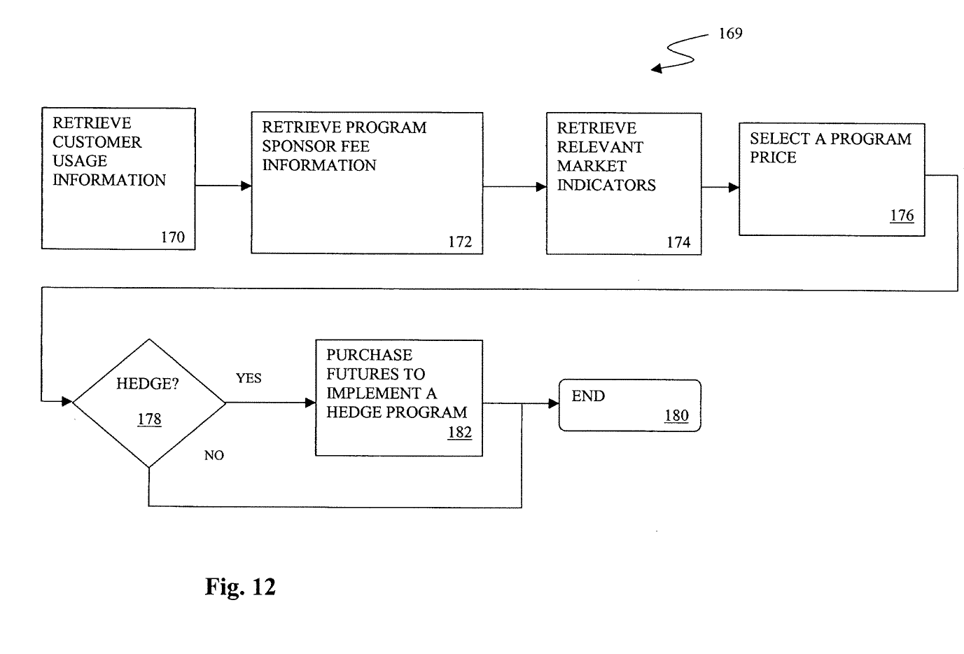

With reference now to FIG. 12, an embodiment of the invention is shown in process 169 for calculating a program price and optionally implementing a financial risk hedge program. Initially, the customer usage information is retrieved from the customer incentive database (step 170) and program sponsor fee information, if any, is retrieved from the customer incentive database (step 172). Relevant market indicators to be considered for developing a hedging program based on the purchase of a fuel futures contract are retrieved from available sources (step 174). Relevant market indicators, well known to those in the art, include the current exchange prices, current interest rates, current futures cost and other information relative to pricing futures contracts.

Based on this information, a decision is made as to what type of program price will be provided the customer (step 176). The variables to be considered include but are not limited to: the customer usage data, the program sponsor fee information (if any program sponsor exists), the relative market indicators that would determine the cost of futures contracts and the risk profile, or ability to assume risk, of the incentive system operator. Pricing programs include but are not limited to: a cap (also known as a call option since the consumer in effect ‘calls’ the fuel at the option price), a discount in an absolute dollar value, i.e. a fixed dollar amount off of the pump purchase price, and a discount relative to the purchase price at the pump, i.e. a percentage discount off of the pump purchase price.

A decision is made as to whether the incentive program operator wishes to hedge the risk (step 178). If the decision is made not to hedge the risk, then the process ends (step 180). In such a circumstance, the incentive program operator assumes the risks associated with a change in the cost variables described above on which the program price was determined. If a decision is made to hedge the risk, then appropriate fuel oil futures contracts are purchased (step 182). It will be understood that, in contrast to taxes and shipping costs as described above, fuel oil price variations is one factor that may be hedged through the purchase of future contracts.

The purchase of fuel oil futures contracts is a procedure well known to those skilled in the art. If such contracts are purchased in accordance with the present invention to hedge financial risk associated with fuel oil price variations, the quantity and size of such futures contracts are determined based on estimated customer fuel usage information, the type and dollar amount of program sponsor fees, the program price provided to the customer and the current market conditions and futures contracts pricing and conditions.

In one embodiment of the invention, monthly futures contracts are purchased based on the total incentive program size, i.e. numbers of participants, and consideration of all relevant data provided above across all participants for each month. The conditions of each participant will, of course, be individual or will position the participant within a group of like customers. The conditions associated with some participants may present a low risk to the incentive program operator, for example if they live in a historically low-fuel-cost geographic area and are in the program for a small quantity of fuel over a short period of time. Other participants may establish conditions creating a high risk, for example if they live in high-fuel-cost areas and under the program may purchase large quantities of fuel over a long period of time. The decision as to hedging strategy will be based on a roll-up of all participant information.

Those skilled in the art will now recognize many different methodologies for determining a program price and financial risk hedging strategy in accordance with the present invention.

For purposes of illustration, in the first described embodiment the program price provided in the incentive program is independent of geographic location and exclusive of taxes. That is, the consumer price comprises a fixed, geographically independent base price plus the cost of taxes associated with each purchase of fuel.

Continuing again with reference to FIG. 3, subsequent to the calculation of the consumer program price (step 76), the program price is transmitted to the automobile dealer for providing to the buyer (step 78) and to the incentive system controller 14 (step 80) for storage in association with the customer account information in customer incentive database record 36 (step 82).

In the described embodiment, the consumer will thus be informed that his program price under the incentive program comprises a fixed, geographically independent base price plus the actual cost of taxes. If, alternatively, the program price were dependent on geography, the consumer would be provided with a ‘state card’ indicating the program price in each state (or other selected geographic region).

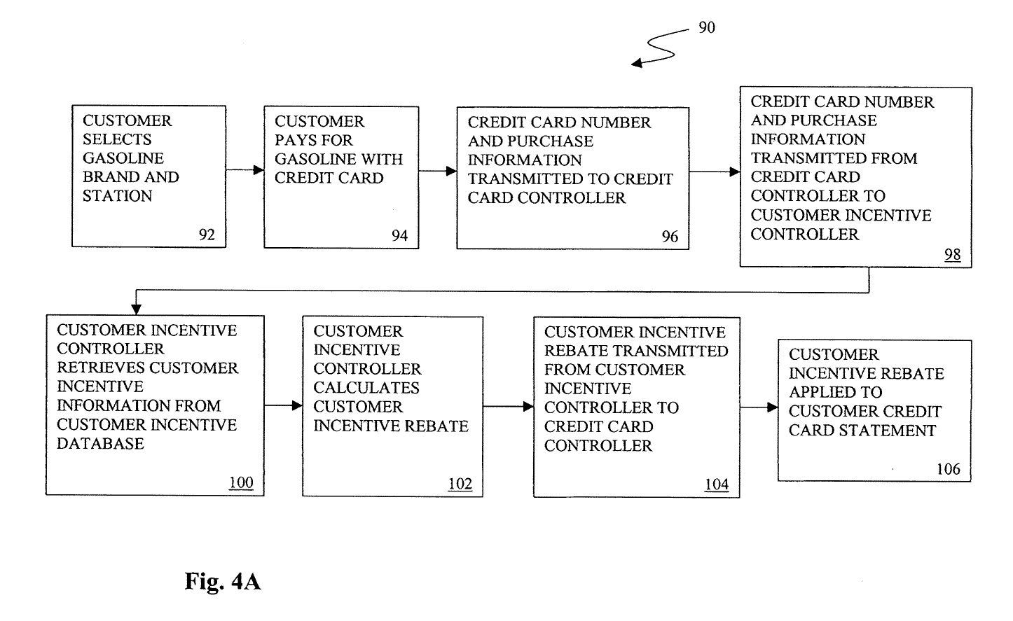

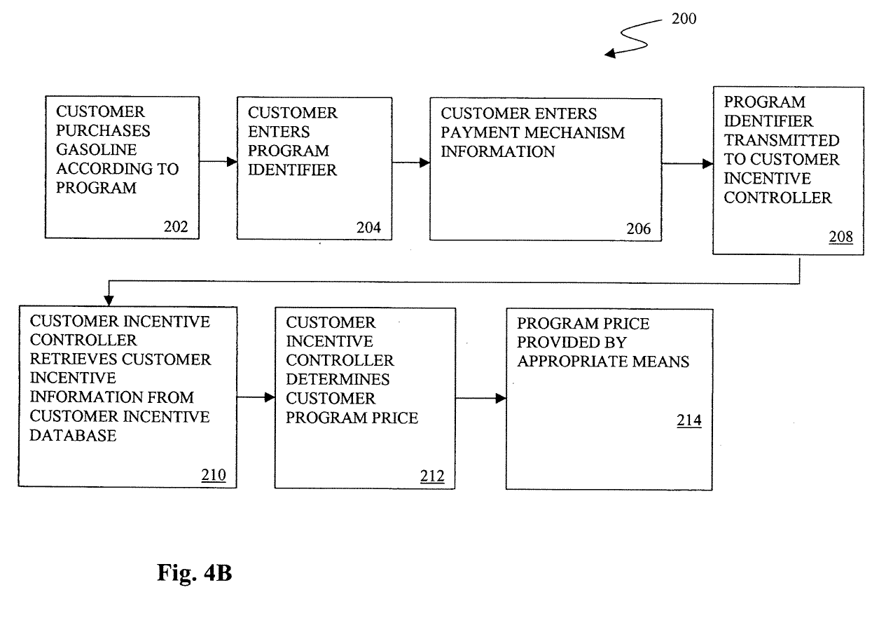

With reference now to FIG. 4A there is shown a process 90 for applying the gasoline incentive, in the form of a rebate against a gasoline purchase, to a customer credit card.

A customer purchases gasoline, selecting a brand and a grade consistent with the terms of the incentive program (step 92) which has been provided to him by the dealer in the manner described above. The customer completes the purchase using the credit card registered with the incentive program for payment (step 94) and the purchase information is transmitted in a conventional manner to credit card controller 12 (step 96).

Based on the customer name and/or credit card account number (or other appropriate identifying information) stored in credit card database record 32, credit card controller 12 identifies the gasoline purchase as subject to an incentive program. Using the incentive program information in database record 32 (FIG. 10), credit card controller 12 transmits the gasoline purchase information to incentive system controller 14 (step 98). Incentive system controller retrieves the customer incentive information from customer incentive database record 36 in customer incentive database 26 (step 100) and calculates the rebate due to the customer (step 102) (described in detail below). The customer incentive rebate is transmitted from incentive system controller 14 to credit card controller 12 (step 104), where the rebate is applied to a customer credit card statement.

Thus in the present embodiment of the invention, a beneficiary of the inventive incentive program would receive a credit card bill including at least two line items pertinent to the subject incentive program: a first line item indicating the market cost of a gasoline purchase, and a second line item indicating a rebate credited against the balance due in an amount equal to the incentive. Alternate methods of providing the amount due to the customer under the program will be apparent, and include but are in no way limited to: a credit against a credit card account as described, a credit against a checking account, a direct payment to a customer and a credit against a future, related purchase. Again, details on calculating the incentive rebate as a function of the program price are described below.

With reference now to FIG. 4B, an alternate embodiment 200 is shown operative with the above described embodiments which include program sponsors and with system 10′ of FIG. 2 wherein the customer communicates over the Internet. In this embodiment of the invention, upon the purchase of fuel (step 202), the customer enters the program identifier provided by the program sponsor through an Internet connection (step 204). The Internet connection may, for example, be a terminal on the pump itself, a terminal at the station, or through a cell phone or personal digital assistant or other remote device. The program identifier might be a credit card account number, in which case the process is as described in FIG. 4 above. If the identifier is not a credit card account number, the customer next enters a payment mechanism (step 206) for transmission to the customer incentive controller (step 208). This may be a credit card number (different from the program identifier), a debit account number, a request for a cash transfer or one of many other known payment mechanisms.

Continuing with reference to FIG. 4B, the customer incentive controller retrieves the customer incentive program information (step 210) and determines the program price (step 212). Subsequently, dependent on the program identifier used and the sponsor involved, the system determines how to provide the program price to the customer (step 214). If the program sponsor and identifier identify a credit card account, there may be a credit applied to a credit card bill as described above. If the program sponsor is the gasoline company, there may be a discount applied directly at the pump. Similarly, if the program sponsor is a bank, there may be a credit applied at the pump with a separate payment made to the gasoline company. If, as another example, the sponsor were a food company, a credit could be provided for use during the next purchase of food products from the sponsor.

In the event that the program identifier identifies a prepaid account, that account is debited in accordance with the program price of the fuel purchase while, unless other arrangements have been established with the fuel provider, the fuel provider is paid the full retail price.

It will be appreciated that many different payment mechanisms accommodating discounts, rebates, credits and the like will now be apparent to the reader.

### EXAMPLE I

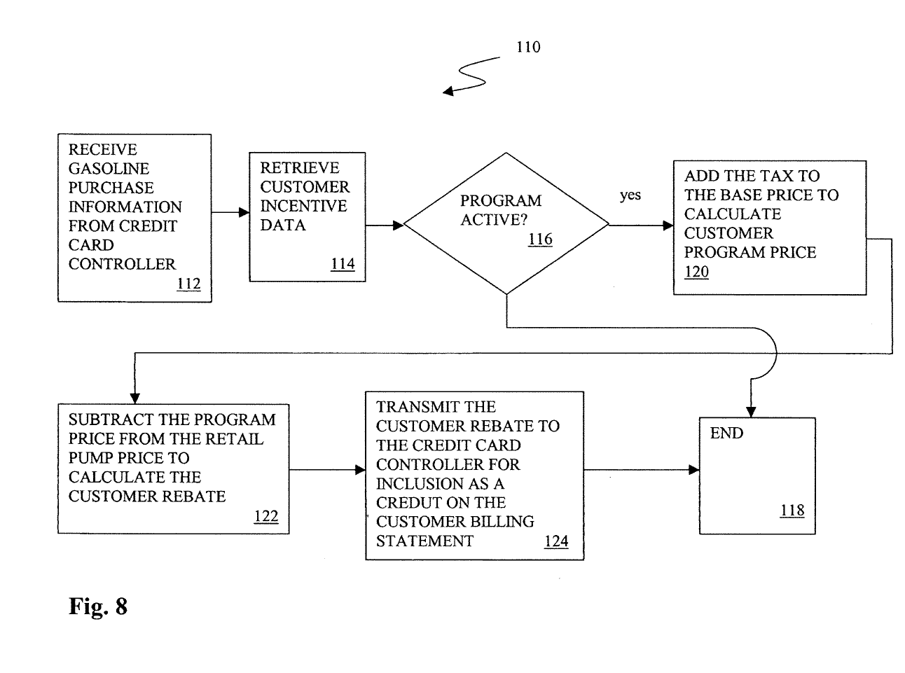

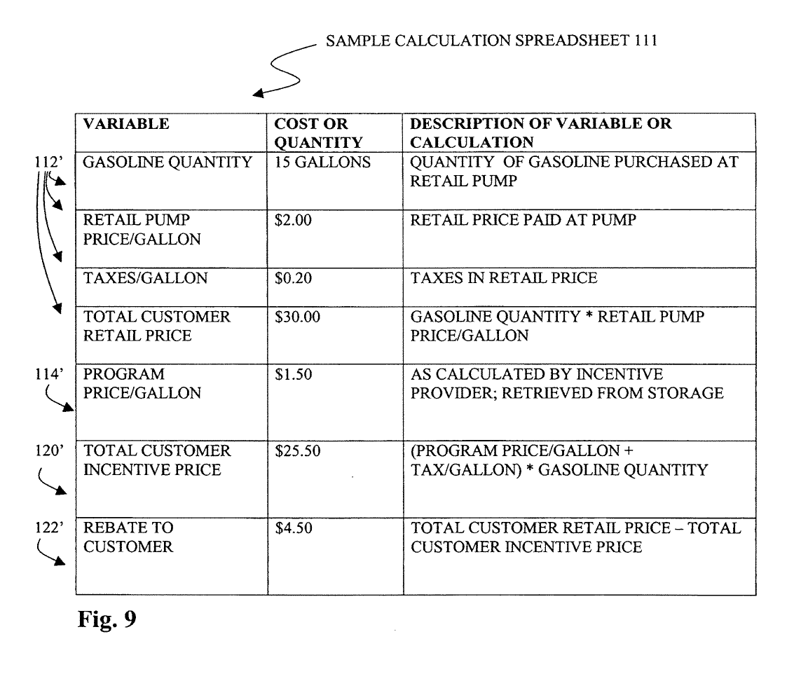

With reference now to FIGS. 8 and 9, an exemplary method of calculating a customer incentive in the form of a rebate is shown and described. As described above, in this example the sponsor is a credit card company and payment mechanism is a credit card. There is no sponsor payment to the incentive program operator and the incentive program operator may or may not have hedged risk. The incentive price is a capped price and taxes, if any and regardless of their value, are added to the incentive price. Steps indicated in FIG. 8 are shown as like numbered, ‘primed’ entries in the exemplary spreadsheet table 111 of FIG. 9.

With reference now to FIG. 8, incentive system controller 14 receives gasoline purchase information from credit card controller 12 in the manner described above. This information includes a date of purchase (which may be assumed to be the date the purchase information is provided to the controller since credit card purchases are typically ‘cleared’ on a real-time basis), a quantity in gallons, a retail pump price, a tax/gallon, and the total purchase price (step 112, spreadsheet entries 112′). Customer incentive data is retrieved from data record 36 in customer incentive database 26 (step 114) and preliminary checks are completed to determine if this purchase is subject to the incentive rebate (step 116). One such check includes whether the customer has exceeded the number of gallons/month provided in the incentive program. Other such checks include the brand and grade of gasoline, as well as the date range of the purchase relative to the active dates of the program. If the incentive program does not cover the purchase, the process terminates (step 118).

Assuming that the purchase is subject to the incentive program, the tax is added to the base price to calculate a customer program price, the customer program price being multiplied by the number of gallons purchased to determine a total customer program price for the particular fuel purchase (step 120, spreadsheet entry 120′). The total customer program price is subtracted from the retail pump price to calculate the rebate, credit or direct payment due to the customer (step 122, spreadsheet entry 122′). The customer rebate is transmitted from the incentive system controller 14 to credit card controller 12 for application as a credit to a customer credit card statement (step 124) and the process ends (step 118).

In the described embodiment, the tax is received from the gasoline pump. Alternatively, the tax may be received from another source, such as tax tables maintained by a public or private source.

### EXAMPLE II

There will now be described another example wherein:
the program sponsor is the gasoline company supplying gasoline under the incentive program,
the gasoline company provides a one-time payment to the incentive program sponsor for each additional customer added to the program,
the incentive program operator, for example an investment bank as described above, desires to hedge the risk associated with fluctuations in price of fuel oil,
payment is made by the customer through an internet terminal at the point-of-purchase at the pump, and
the customer selects a credit card for payment and the incentive price is capped exclusive of taxes as described in Example I above.

In this example, initially, upon the sale of an automobile in accordance with process 50 of FIG. 2, the customer establishes a relationship with and receives a program identifier from the gasoline company in accordance with process 149 of FIG. 11. Since this program sponsor is also the program gasoline supplier it is likely this will be done at the automobile dealership through a pre-arranged relationship between the gasoline supplier and the automobile company.

The program price is determined in accordance with processes 71 (FIG. 3) and 169 (FIG. 12). During this process, the incentive program operator develops and implements a hedge strategy (FIG. 12) based in part on the one-time sponsor payment. As described in detail above, this strategy will typically involve the purchase of fuel oil futures in quantities based on the facts associated with large groups of program participants.

Subsequently, the customer makes a gasoline purchase in accordance with process 200 of FIG. 4B. Upon the purchase of fuel, the customer enters the program identifier into the pump terminal and indicates a desire to pay by credit card including identifying the card account. A program price is retrieved over the Internet and a record of the transaction is created and stored in accordance with the above-described processes and systems. The gasoline purchase is charged against the identified credit card account and the customer is provided the customer price through one of several different processes. In one embodiment, the customer receives a credit to the credit card account as described above. In another embodiment, the customer is simply billed less on the credit card and a payment is made from the incentive program operator to the gasoline company in accordance with a prearranged agreement.

There is thus provided new and improved methods and systems for providing fuel purchase incentives in association with the sale of vehicles. The invention motivates the sale/purchase of fuel-powered vehicles such as automobiles and provides features whereby a seller can hedge his risks and a buyer can receive the incentive in different ways. The invention has application in the fields of distribution of fuel-powered vehicles.

While the invention has been shown and described with respect to detailed embodiments, numerous other variations and improvements falling within the scope of the invention will occur to those knowledgeable in the art.

1. A method operable on a computer for providing a program price for the purchase of a vehicle fuel, comprising:
determining usage information including geographic usage information;
receiving program sponsor data relating to the vehicle fuel;
determining, based on the usage information and the program sponsor data, a hedge strategy for the vehicle fuel;
calculating, on the computer, using the hedge strategy and the program sponsor data, the program price for the vehicle fuel; and
guaranteeing the program price.

2. The method of claim 1 wherein the step of guaranteeing includes guaranteeing the program price to a consumer, and further including:
identifying the consumer;
establishing for the consumer an account including an account identifier; and
storing the program price in association with the account identifier on the computer.

3. The method of claim 2 and further including:
receiving purchase information indicating a purchase of said automotive fuel at a retail price using said account identifier;
retrieving said program price from said computer; and
calculating, using said program price and said retail price, a payment due to said customer.

4. The method of claim 3 wherein the program price is a discount to the retail price.

5. The method of claim 3 wherein said program price is a capped price.

6. The method of claim 3 wherein the program price includes at least one of an effective time period, a grade of the automotive fuel and a brand of the automotive fuel; and
the purchase information includes at least one of a date of purchase, a quantity of purchase, a grade of the automotive fuel and a brand of the automotive fuel.

7. The method of claim 3 wherein said payment due to said customer is provided as a credit to the account identified by said account identifier.

8. The method of claim 1 wherein the step of determining the hedge strategy is further based upon at least one market indicator.

9. A method in accordance with claim 1 wherein said sponsor data includes a fee paid by said program sponsor.

10. A method in accordance with claim 9 wherein said fee comprises a one-time payment by said program sponsor.

11. A method in accordance with claim 10 wherein said fee comprises multiple payments each contingent on the occurrence of an event.

12. A method in accordance with claim 11 wherein said event is the purchase of said vehicle fuel by a customer.

13. A method in accordance with claim 9 wherein said fee is for the establishment of a new customer account.

14. A method in accordance with claim 1 wherein said usage data further includes a quantity of fuel to be purchased, a number of months during which said program price will apply and a type of fuel to be purchased

15. A method in accordance with claim 1 wherein said step of calculating said program price includes calculating multiple program prices for multiple geographic regions.

16. The method of claim 1 wherein said program price is inclusive of taxes on the automotive fuel.

17. The method of claim 1 wherein the program price is exclusive of taxes on the automotive fuel.

18. A method in accordance with claim 1 wherein said hedge strategy includes purchasing a futures contract on said vehicle fuel.

19. A system for providing a program price for the purchase of a vehicle fuel, comprising:
a processor;
a memory connected to the processor storing instructions to operate the processor to perform the steps of
determining usage information including geographic usage information;
receiving program sponsor data relating to the vehicle fuel;
determining, based on the usage information and the program sponsor data, a hedge strategy for the vehicle fuel;
calculating, on the computer, using the hedge strategy and the program sponsor data, the program price for the vehicle fuel; and
guaranteeing the program price.

20. The system of claim 19 wherein the step of guaranteeing includes guaranteeing the program price to a consumer, and further including:
identifying the consumer;
establishing for the consumer an account including an account identifier; and
storing the program price in association with the account identifier on the computer.

21. The system of claim 20 and further including:
receiving purchase information indicating a purchase of said automotive fuel at a retail price using said account identifier;
retrieving said program price from said computer; and
calculating, using said program price and said retail price, a payment due to said customer.

22. The system of claim 21 wherein the program price is a discount to the retail price.

23. The system of claim 21 wherein said program price is a capped price.

24. The system of claim 21 wherein the program price includes at least one of an effective time period, a grade of the automotive fuel and a brand of the automotive fuel; and
the purchase information includes at least one of a date of purchase, a quantity of purchase, a grade of the automotive fuel and a brand of the automotive fuel.

25. The system of claim 21 wherein said payment due to said customer is provided as a credit to the account identified by said account identifier.

26. The system of claim 19 wherein the step of determining the hedge strategy is further based upon at least one market indicator.

27. A system in accordance with claim 19 wherein said sponsor data includes a fee paid by said program sponsor.

28. A system in accordance with claim 27 wherein said fee comprises a one-time payment by said program sponsor.

29. A system in accordance with claim 28 wherein said fee comprises multiple payments each contingent on the occurrence of an event.

30. A system in accordance with claim 29 wherein said event is the purchase of said vehicle fuel by a customer.

31. A system in accordance with claim 27 wherein said fee is for the establishment of a new customer account.

32. A system in accordance with claim 19 wherein said usage data further includes a quantity of fuel to be purchased, a number of months during which said program price will apply and a type of fuel to be purchased

33. A system in accordance with claim 19 wherein said step of calculating said program price includes calculating multiple program prices for multiple geographic regions.

34. The system of claim 19 wherein said program price is inclusive of taxes on the automotive fuel.

35. The system of claim 19 wherein the program price is exclusive of taxes on the automotive fuel.

36. A system in accordance with claim 19 wherein said hedge strategy includes purchasing a futures contract on said vehicle fuel.

37. A system for providing a program price for the purchase of a vehicle fuel, comprising:
means for determining usage information including geographic usage information;
means for receiving program sponsor data relating to the vehicle fuel;
means for determining, based on the usage information and the program sponsor data, a hedge strategy for the vehicle fuel;
means for calculating, on the computer, using the hedge strategy and the program sponsor data, the program price for the vehicle fuel; and
means for guaranteeing the program price.

38. A program product storing instructions operable on a computer for providing a program price for the purchase of a vehicle fuel, the instructions to operate the computer to perform a method, comprising:
determining usage information including geographic usage information;
receiving program sponsor data relating to the vehicle fuel;
determining, based on the usage information and the program sponsor data, a hedge strategy for the vehicle fuel;
calculating, on the computer, using the hedge strategy and the program sponsor data, the program price for the vehicle fuel; and
guaranteeing the program price.
